(19) United States
(12) Patent Application Publication
(10) Pub. No.: US 2025/0165278 A1
(43) Pub. Date: May 22, 2025

(54) CONSOLIDATION OF INTERRUPT LOST EVENTS IN MULTI-LEVEL INTERRUPT SYSTEM

(71) Applicant: Infineon Technologies AG, Neubiberg (DE)

(72) Inventor: Frank Hellwig, Wunstorf (DE)

(21) Appl. No.: 18/597,086

(22) Filed: Mar. 6, 2024

Related U.S. Application Data
(60) Provisional application No. 63/601,994, filed on Nov. 22, 2023.

(51) Int. Cl. G06F 9/48; G06F 9/30

(52) U.S. Cl. CPC G06F 9/4831; G06F 9/30036; G06F 9/3009

(57) ABSTRACT

Systems, methods, and circuitries are provided for detecting lost interrupt events in a reduced instruction set computer-V (RISC-V) architecture. An example architecture includes an advanced platform level interrupt controller (APLIC) and an incoming message signaled interrupt (MSI) controller (IMSIC) coupled to the APLIC. The APLIC includes a plurality of respective vectors connected to respective external interrupt inputs, wherein each vector is mapped to an interrupt priority and each vector comprises a vector interrupt lost (IL) bit. The IMSIC is configured to receive MSI from the APLIC and to maintain an interrupt file that includes a set of a set of interrupt lost (IL) bits indexed by interrupt priority.

### CROSS-REFERENCE TO RELATED APPLICATIONS

This application claims the benefit of priority from U.S. Provisional Patent Application 63/601,994 filed on Nov. 22, 2023 and entitled CONSOLIDATION OF INTERRUPT LOST EVENTS IN MULTI-LEVEL INTERRUPT SYSTEM, the contents of which are hereby incorporated in their entirety.

### FIELD

The present disclosure relates generally to the field of processors and central processing units (CPUs) and more particularly to an interrupt architecture of a processing system.

### BACKGROUND

Modern processors may include multi-level interrupt systems in which multiple sources may provide wired and/or message signaled interrupts and different interrupts may have different priorities and target different hardware threads.

### BRIEF DESCRIPTION OF THE DRAWINGS

Some examples of circuits, apparatuses and/or methods will be described in the following by way of example only. In this context, reference will be made to the accompanying Figures.

FIG. 1 is a block diagram of an exemplary multi-level interrupt architecture, in accordance with various aspects described.

FIG. 2 is a block diagram of a particular example of the exemplary architecture of FIG. 1, in accordance with various aspects described.

FIG. 3 is a block diagram of an exemplary multi-level interrupt architecture that supports indication of lost interrupt events, in accordance with various aspects described.

FIG. 4 is a block diagram of an exemplary multi-level interrupt architecture that supports indication of lost interrupt events, in accordance with various aspects described.

FIG. 5 is a flow diagram of an example method for providing information about lost interrupt events to a computing core, in accordance with various aspects described.

FIG. 6 is a flow diagram of an example method for providing information about lost interrupt events to a computing core, in accordance with various aspects described.

### DETAILED DESCRIPTION

The present disclosure is described with reference to the attached figures. Similar components in various figures may be represented by similar reference characters. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

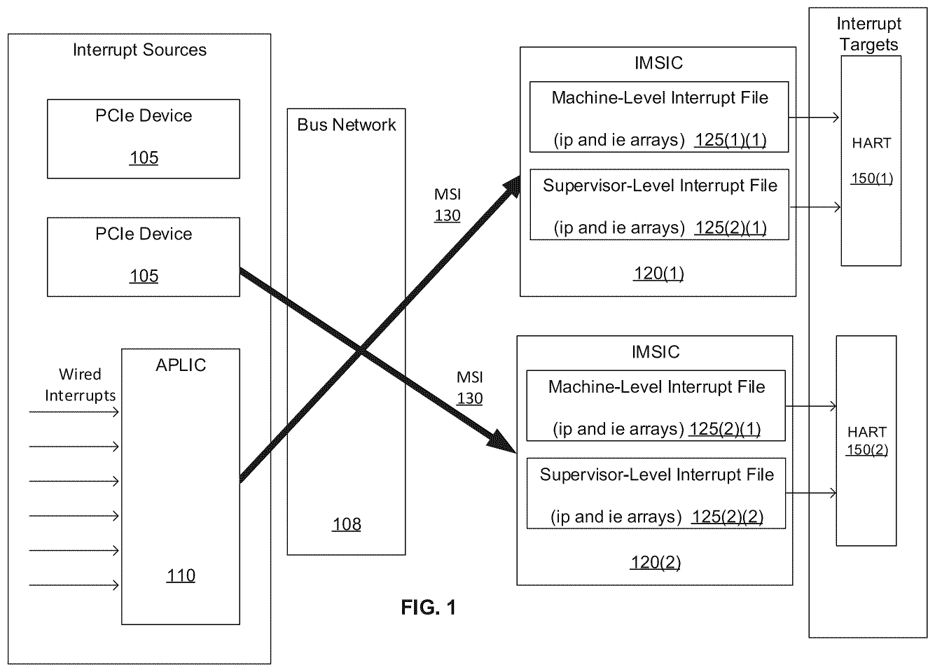

FIG. 1 is a block diagram of an interrupt architecture for a reduced instruction set-V (RISC-V) system. The architecture of FIG. 1 is configured to handle external interrupts for multiple hardware threads (harts) as well as other interrupt targets. The architecture of FIG. 1 includes several interrupt sources: an advanced platform-level interrupt controller (APLIC) 110 and two peripheral component interconnect express (PCIe) devices 105. The interrupt sources are coupled, by way of a bus network 108, to two incoming message signaled interrupt controllers (IMSICs) 120 for two respective harts 150 (e.g., processor cores or CPUs).

The APLIC 110 receives wired external interrupts. Each external interrupt received by the APLIC 110 has an associated interrupt target, which includes a particular hart (and in some examples a particular privilege level of the hart) and an associated interrupt priority. The APLIC 110 translates the wired external interrupts into message signaled interrupts (MSIs) 130 that communicate interrupt information about a received interrupt (e.g., the interrupt priority and the interrupt target).

The PCIe devices 105 also generate MSIs 130 that communicate information about interrupts generated by the PCIe device.

The bus network 108 routes each MSI to an appropriate IMSIC 120 for the hart of the interrupt target indicated by the MSI. The IMSIC 120 maintains interrupt information for each interrupt target. In the illustrated example, the interrupt information is stored as bit arrays in one or more interrupt files 125. An interrupt file 125 is maintained for each privilege level of the hart. In FIG. 1, a machine-level interrupt file is maintained for a machine level privilege and a supervisor-level interrupt file is maintained for a supervisor level privilege. In other examples, interrupt files may be maintained for different virtual machines/guest IDs as well. In each interrupt file interrupt pending (IP) and interrupt enable (IE) bit arrays include a bit for each interrupt priority and these bits are addressed by interrupt priority. Thus, the “interrupt target” may be considered as a particular IP bit in a particular bit array of a particular interrupt file maintained by an IMSIC 120 for its particular hart 150.

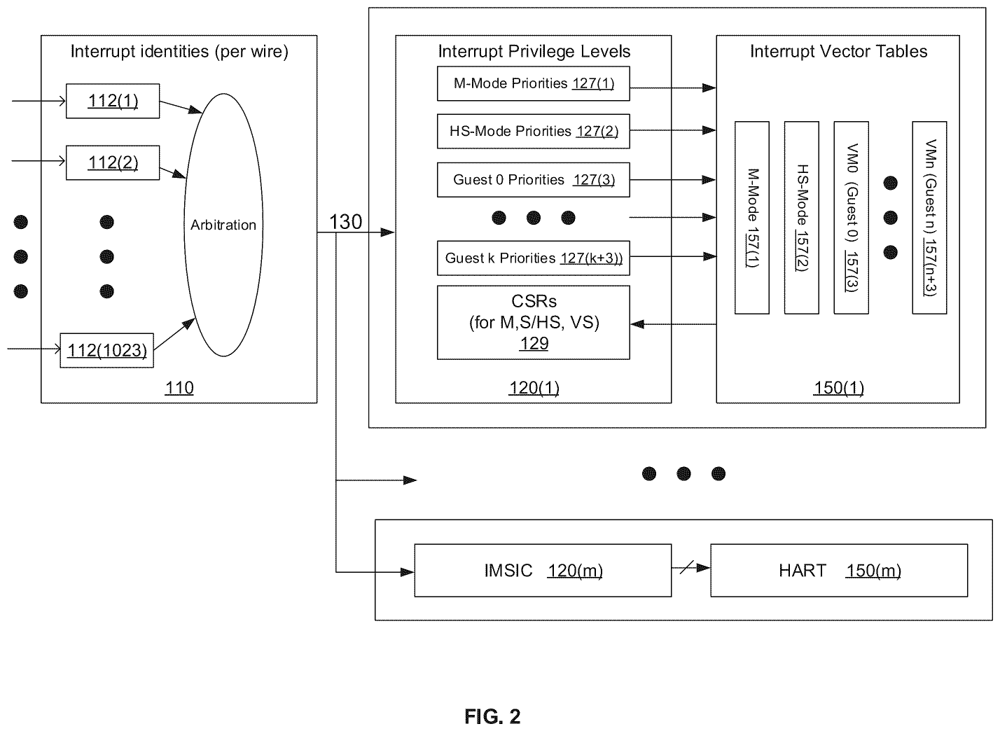

Referring now to FIG. 2, aspects of the interrupt architecture of FIG. 1 are shown in additional detail. The APLIC 110 defines interrupt identities for core external interrupts (wired or software interrupts). The APLIC 110 interrupt identities are related to physical interrupt lines or software interrupt structures. The APLIC 110 includes per-interrupt control registers 112(1-1023) that store bit vectors, with each vector corresponding to a unique interrupt identity. Each control register maps a received interrupt on a particular line to a hart-ID and a privilege level within the hart which can be M-Mode (Machine Mode), S-/HS-Mode (Supervisor or Hypervisor Supervisor Mode), or VSx (GuestID—Virtual Machine×Supervisor Mode). Each control register 112 configures a received interrupt with a priority (External Interrupt Identity Number—EIID) and provides measures to set, store, and clear interrupt pending information (e.g., an IP bit) and interrupt enable information (e.g., an IE bit) for the interrupt as well as measures to define an event situation for each incoming interrupt line.

The APLIC 110 arbitrates pending interrupts a per hart privilege level granularity and signals the information of the winning interrupt as an MSI 130 to a target hart's local IMSIC 120. The MSI 130 indicates an interrupt target, which includes the configured HART ID, privilege level, and the Interrupt priority (EIID). On signaling an MSI 130 for the arbitrated pending interrupt, the APLIC clears the Interrupt Pending (IP) information in the control register for the respective APLIC interrupt identity. It is noted that there can be more than one APLIC in the system that signals MSIs to the IMSIC modules.

Each hart 150 is coupled to a dedicated IMSIC 120. The IMISC 120 provides (e.g., maintains and stores) interrupt files 127, one file for each supported privilege level (M, S/HS) and one file for each supported Guest-ID (Virtual Machine). Each interrupt file 127 has a configurable number of priorities that are related to the hart's interrupt vector tables 157. For each privilege level and maybe also for each virtual machine (Guest), the IMSIC 120 provides an interrupt file 127 that includes one interrupt pending (IP) bit for each priority level and one interrupt enable (IE) bit for each priority level.

While an interrupt for a given privilege/priority is pending in the APLIC 110 it can happen that the APLIC receives one or more new interrupts through its respective interrupt input signals and/or through software writes that intend to set an already set interrupt pending bit of a vector stored in a control register. In other words, the APLIC 110 may receive an interrupt for a given target before the APLIC has had a chance to signal a previous interrupt for the same target. Further, while a specific interrupt priority in the IMSIC 120 is pending, the IMSIC may receive further MSIs addressing the same interrupt priority again. These subsequent interrupts may not be captured in existing systems and are called lost interrupts or lost interrupt events. In some safety related contexts, such as automotive applications, it can be important to detect situations when one or more interrupts are lost either at the APLIC or IMSIC level.

Systems, methods, and architectures are provided herein that support the detection and consolidation of lost interrupt events for notification of same to a processing core. In one example, APLIC and IMSIC interrupt identities are extended with lost interrupt detection mechanisms and lost interrupt information structures. Lost interrupt information is signaled together with the respective MSI (which includes information about priority, target core, target privilege level, extended by the information lost information) from the APLIC to an IMSIC. The IMSIC consolidates MSI signaled lost interrupt information but can also detect interrupt lost events on priority level. The IMSIC may then make the lost interrupt information available to the respective core.

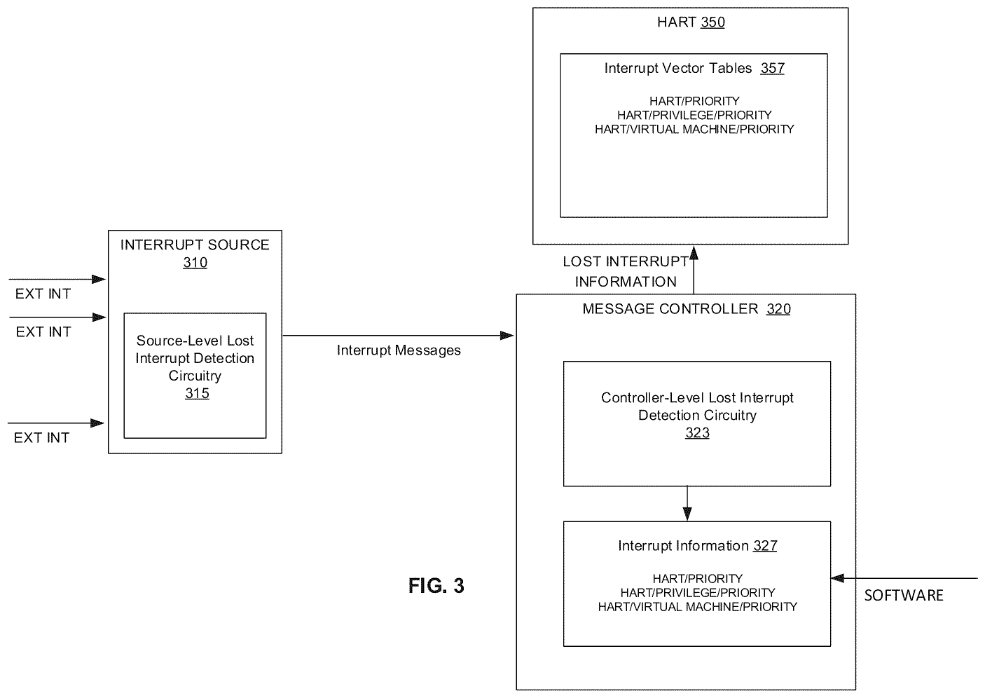

FIG. 3 is a block diagram of a general interrupt architecture that supports communication of lost interrupt occurrences to a hardware thread. In one example, the interrupt architecture is a modified RISC-V advanced interrupt architecture. However, the disclosed solutions may be applied in any processing environment.

The architecture includes hardware components arranged into a hart 350, an interrupt sources 310, and a message controller 320 for the hart. The hart 350 includes interrupt vector tables 357 mapped to multiple interrupt targets. Each interrupt target is associated with a given priority for the hart. In some examples, the hart includes an interrupt target for each privilege or and/or each virtual machine. The setting of interrupt targets or their associated values in the interrupt vector tables 357 may cause the hart to take some action (potentially different actions for different interrupt targets) in response to the interrupt. In some circumstances if multiple interrupts occur for the same interrupt target in relatively quick succession (e.g., to close together for individual signaling by way of interrupt messages so that a lost interrupt occurs) the response to the interrupt may be prioritized higher than a single occurrence of the interrupt would be. Alternatively, a different response may be taken by the hart when a lost interrupt is detected.

The interrupt source 310 (e.g., APLIC of FIG. 1) is configured to receive respective external interrupt signals indicative of respective interrupt events. Each interrupt event is associated with a corresponding interrupt target. The interrupt source transmits interrupt messages (e.g., MSIs) based on the received interrupt signals. Each MSI includes, for an interrupt event, information about the interrupt target of the interrupt event.

The interrupt source may include source-level lost interrupt detection circuitry 315 that performs a lost interrupt detection function. In one example, to detect a lost interrupt event, the source-level lost interrupt detection circuitry 315 detects that an interrupt signal for a second interrupt event for a given interrupt target is received prior to the interrupt source 310 transmitting an interrupt message for a first interrupt event for the given interrupt target. For example, the source-level lost interrupt detection circuitry 315 may detect an interrupt lost event when it receives an interrupt for an interrupt target whose interrupt pending (IP) bit in a vector for the interrupt target is already set. In response, the source-level lost interrupt detection circuitry 315 stores an indication that an interrupt was lost for the given interrupt target (e.g., by setting a vector interrupt lost (IL) bit in the vector for the interrupt identity). The interrupt source 310 encodes the interrupt lost event information in a pending (e.g., in the arbitration queue) interrupt message that communicates information about the first-received interrupt. The interrupt source may be further configured to clear the indication that an interrupt was lost (e.g., the vector IL bit) in response to transmitting the interrupt message that indicates the lost interrupt.

The message controller 320 (e.g., IMSIC of FIG. 1) is configured to receive interrupt messages from the interrupt source 310 and, based on the received messages, store interrupt information for the interrupt targets. The message controller 320 includes controller-level lost interrupt circuitry 323 that determines (e.g., based on one or more of the received interrupt messages) that an interrupt event for an interrupt target has been lost. In response, the message controller 320 provides an indication of one or more lost interrupt events to a target hart 350 of the affected interrupt target.

The controller-level lost interrupt circuitry 323 detects a lost interrupt and stores information reflecting the lost interrupt as interrupt information. The controller-level lost interrupt circuitry 323 may be configured to detect that an interrupt has been lost in response to either receiving an interrupt message that indicates a lost interrupt for a given target or receiving an interrupt message for a given target when the interrupt information 327 indicates that an interrupt is already pending for the given target. The message controller 320 may be configured to reset the lost interrupt information 327 for an interrupt target in response to a different interrupt target having the same or greater privilege than the given interrupt target receiving an indication of the one or more lost interrupt events. Alternatively or additionally, the lost interrupt information for an interrupt target may be set or reset by software.

The message controller 320 may be configured to signal the indication of one or more lost interrupt events on a per interrupt priority basis or on a per interrupt target basis. Thus, the MSI controller consolidates information about lost interrupt events from multiple sources and provides the information to a hart so that the hart may take responsive action.

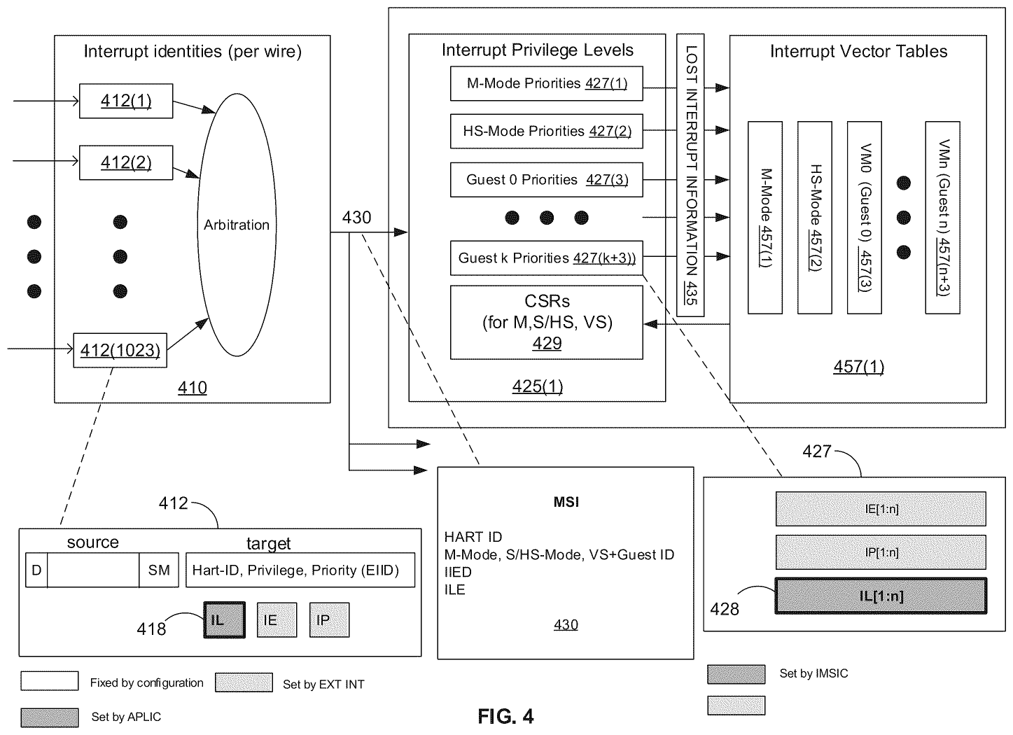

FIG. 4 is a block diagram of an example RISC-V interrupt architecture that is a modification of the architecture of FIGS. 1 and 2 and provides detection, consolidation, and indication of lost interrupt events. The architecture of FIG. 4 is a specific example of the architecture of FIG. 3 and aspects of the illustrated architecture may be implemented by the general architecture of FIG. 3.

In the illustrated architecture, the APLIC control registers 412 have been modified to store a vector interrupt lost (IL) bit for each interrupt identity. The APLIC 410 has been modified to set and (optionally) reset the vector IL bit. The MSI messages 430 include one or more bits encoding the status of a vector IL bit 418. The IMSIC is modified to add an array 428 that includes one interrupt lost (IL) bit per interrupt priority or per group of interrupt priorities.

An example vector format for an interrupt identity as stored by control registers 412 is illustrated in FIG. 4. Bits encoding source information, target identity, and interrupt priority (EIID) are set by configuration of the architecture. An IE bit and IP bit are set by the received external interrupt. The APLIC 410 (e.g., source-level lost interrupt detection circuitry of FIG. 3) sets the vector IL bit when a new interrupt event is detected for an interrupt identity while that interrupt identity's IP bit is already set. When the interrupt identity is arbitrated, its current vector IL bit status is signaled as part of a modified MSI message 430. When an interrupt lost situation is detected in parallel to the MSI signaling/interrupt pending clear, the vector IL information may be set and signaled with the next interrupt through the MSI. The vector IL information may be cleared by software or by the APLIC 410 when the vector IL information it is signaled through an MSI message 430. The APLIC 410 may detect lost interrupt events with different granularities (e.g., per interrupt or per group of interrupts).

The enhanced MSI 430 indicates, for an interrupt, a target hart ID, a privilege level, a priority (IIED), and an indication of the vector IL bit status of the signaled interrupt identity.

The IMSIC interrupt files 427 are modified to add one interrupt lost bit (IL) per interrupt privilege level or per group of interrupt privilege levels. For example an additional array of bits 428 may be included in an interrupt file to store n IL bits, indexed by n interrupt priorities. While the IE bits and IP bits are set by MSIS 430, the IMSIC 420 (e.g., controller-level lost interrupt detection circuitry of FIG. 3) sets the IL bits. For example, when an MSI for an interrupt identity is received by the IMSIC 420 while interrupt identity's related priority IP bit is already set, the IMSIC will set the IL bit for the priority. The IMSIC 420 may set the IL bit associated with a given priority in response to receiving an MSI indicating that a vector IL bit is set for an interrupt identity having the given priority. The IL information may be cleared by software and/or the IMSIC 420.

The IL information may be provided to the interrupt target through a standard IMSIC register interface and may be cleared together with the IP bit. The IL information may be provided directly to respective privilege level/priority interrupt vector tables 457 of the target hart 450.

The granularity with which lost interrupt information is detected, consolidated, and reported may be on a per priority/privilege level basis, a per priority/a virtual machine level basis, per privilege level basis, per hart basis, and so on. The lost interrupt information may be detected, consolidated, and reported with different granularities.

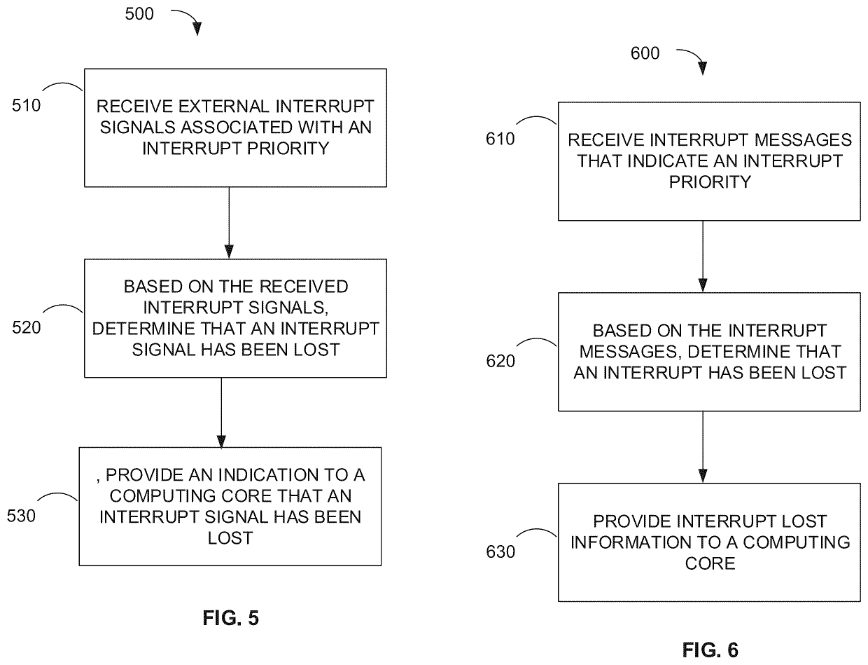

FIG. 5 is a flow diagram outlining an example method 500 for signaling lost interrupt information to a computing core (e.g., a hart). The method 500 may be performed, for example, by an interrupt source 310 of FIG. 3 or an APLIC 110 or 410 of FIGS. 1 and 2 and FIG. 4, respectively. The method includes, at 510, receiving external interrupt signals, each associated with an interrupt priority. Each external interrupt signal may be associated with a preconfigured interrupt identity that includes interrupt source identification, target hart/privilege level identification, and a priority (EIID) for the signaled interrupt. At 520, based on the received interrupt signals, it is determined that an interrupt signal for a given interrupt priority has been lost. In some examples, a lost interrupt signal is detected when an interrupt signal is received for a given interrupt identity before the computing core has been notified of a previous interrupt signal for the given interrupt identity.

In some examples, the method includes providing a plurality of respective vectors connected to respective external interrupt inputs that receive the external interrupt signals. Each vector is associated with a target computing core and includes an indication of an interrupt priority, a vector interrupt pending (IP) bit, and a vector interrupt lost (IL) bit. In these examples, the method includes setting the vector IL bit when an interrupt is received by a corresponding external interrupt input while the vector IP bit is set.

The method 500 includes, at 530, providing an indication to a computing core that the interrupt signal for the given interrupt priority has been lost. In some examples, this operation is performed by selecting a vector based on arbitration rules and transmitting a message signaled interrupt (MSI) to an incoming MSI controller (IMSIC) connected to a target computing core of the selected vector. The MSI includes an indication of the interrupt priority of the selected vector and a status of the vector IL bit of the selected vector.

FIG. 6 is a flow diagram outlining an example method 600 for signaling lost interrupt information to a computing core (e.g., a hart). The method 600 may be performed, for example, by a message controller 320 of FIG. 3 or an IMSIC 120 or 420 of FIGS. 1 and 2 and FIG. 4, respectively. The method includes, at 610, receiving interrupt messages that include an indication of an interrupt priority of a plurality of interrupt priorities. The interrupt messages may be MSIs 130 or 430 of FIGS. 1 and 2 and FIG. 4, respectively. MSIs may include an interrupt lost (IL) bit that is set to indicate that an interrupt signal of the same priority was lost.

The method includes, at 620, determining that an interrupt for a given interrupt priority was lost based on the interrupt messages. In some examples, the method includes receiving an MSI that includes an indication of the interrupt priority and an indication that an interrupt signal for the interrupt priority has been lost and setting an IL bit mapped to the interrupt priority in an interrupt file in response to the MSI message. The method may also include setting an IL bit mapped to the interrupt priority in an interrupt file in response to receiving an MSI that includes an indication of the interrupt priority while an IP bit for the interrupt priority in the interrupt file is already set. The method may include resetting an IL bit mapped to a given interrupt priority in the interrupt file in response to resetting an IP bit mapped to the given interrupt priority in the interrupt file.

The method 600 includes, at 630, providing, to a computing core, respective lost interrupt information for the respective interrupt priorities that indicates whether an interrupt was lost. In some examples, the method includes providing the IL information by way of maintaining one or more interrupt files mapped to respective interrupt targets. In some examples, the status of one or more IL bits may be combined or summarized on a per priority or privilege level basis to generate the lost interrupt information provided to the computing core. The interrupt lost information may be provided to the computing core through a standard IMSIC register interface that includes, in each interrupt file, an IL bit. In some examples, rather than each interrupt file including an IL bit, the IMSIC may maintain a set of IL bits with each IL bit being associated with a group of priorities and/or privileges. In some examples, the lost interrupt information may be provided directly to the affected privilege level of the computing core.

In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

It can be seen from the foregoing description that the disclosed interrupt architecture provides a mechanism that detects interrupt lost events at the functional interrupt level (e.g., APLIC), consolidates them in the privilege level/priority level (e.g., IMSIC), extended with additional (interrupt lost) event detection on priority level, and then makes the information available to the respective processor core or hart and there to the respective privilege mode

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Examples can include subject matter such as a method, means for performing acts or blocks of the method, at least one machine-readable medium including instructions that, when performed by a machine cause the machine to detect and respond to a lost interrupt evet according to embodiments and examples described herein.

Example 1 is a reduced instruction set computer-V (RISC-V) architecture, including an advanced platform level interrupt controller (APLIC) including a plurality of respective vectors connected to respective external interrupt inputs, wherein each vector is mapped to an interrupt priority and each vector includes a vector interrupt lost (IL) bit; and an incoming message signaled interrupt (MSI) controller (IMSIC) coupled to the APLIC, the IMSIC configured to receive MSI from the APLIC and to maintain an interrupt file that includes a set of a set of interrupt lost (IL) bits indexed by interrupt priority.

Example 2 includes the subject matter of example 1, including or omitting optional elements, wherein the IMSIC is configured to set an IL bit mapped to a given interrupt priority of the interrupt file in response to receiving a message signaled interrupt (MSI) that includes an indication of the given interrupt priority and an indication that a vector IL bit of a corresponding vector is set; or receiving an MSI that includes an indication of the given interrupt priority while an interrupt pending (IP) bit for the given interrupt priority in the interrupt file is set.

Example 3 includes the subject matter of example 1, including or omitting optional elements, wherein the IMSIC is configured to reset an IL bit mapped to a given interrupt priority in the interrupt file in response to resetting an IP bit mapped to the given interrupt priority in the interrupt file.

Example 4 includes the subject matter of example 1, including or omitting optional elements, wherein the APLIC is configured to set the vector IL bit of a vector when an interrupt is received by a corresponding external interrupt input while an IP bit of the vector is set; and in response, transmit an MSI to the IMSIC, the MSI including an indication of the interrupt priority of the vector and a status of the vector IL bit of the vector.

Example 5 includes the subject matter of example 1, including or omitting optional elements, wherein the respective vectors are each mapped to a respective interrupt target and a respective interrupt priority of the respective interrupt target; and the IMSIC maintains an interrupt file for each interrupt target.

Example 6 includes the subject matter of example 5, including or omitting optional elements, wherein an interrupt target includes a target hardware thread (hart), a target hart and a privilege level of the target hart, or target hart and virtual machine ID of the target hart.

Example 7 includes the subject matter of example 1, including or omitting optional elements, wherein the APLIC is configured to set an IL bit mapped to a given interrupt vector in response to receiving a new interrupt for the interrupt vector while an interrupt pending (IP) bit for the given interrupt vector is set.

Example 8 includes the subject matter of example 1, including or omitting optional elements, wherein the APLIC is configured to reset an IL bit mapped to a given interrupt vector in response to resetting an interrupt pending (IP) bit mapped to the given interrupt vector when a corresponding interrupt is signaled as an MSI.

Example 9 is an interrupt architecture, including hardware components arranged into one or more hardware threads (harts); an interrupt source configured to receive respective external interrupt signals indicative of respective interrupt events, each interrupt event having a corresponding interrupt target, wherein each interrupt target corresponds to an interrupt priority at a target hart of the one or more harts; based on the received interrupt signals, transmit message signaled interrupts (MSIs), wherein an MSI includes, for an interrupt event, information about the interrupt target of the interrupt event; an MSI controller configured to receive MSIs from the one or more interrupt sources; based on the received MSIs, store interrupt information for interrupt targets; determine that an interrupt event for an interrupt target has been lost; and in response, provide lost interrupt information to a target hart of the interrupt target, the lost interrupt information including an indication of one or more lost interrupt events.

Example 10 includes the subject matter of example 9, including or omitting optional elements, wherein the interrupt target includes an interrupt priority at a privilege level at the target hart or a virtual machine at the target hart.

Example 11 includes the subject matter of example 9, including or omitting optional elements, wherein an MSI of the MSIs that indicates an interrupt event for a given interrupt target includes an indication that an interrupt signal for a subsequent interrupt event for the given interrupt target was received prior to transmission of the MSI.

Example 12 includes the subject matter of example 11, including or omitting optional elements, wherein the MSI controller is further configured to based on the received MSIs, save interrupt information for each interrupt target, the interrupt information indicating whether an interrupt has been lost; and provide lost interrupt information to a target hart associated with the interrupt target for which the interrupt was lost.

Example 13 includes the subject matter of example 9, including or omitting optional elements, wherein the MSI controller is configured to set the interrupt information for a given interrupt target to indicate that an interrupt has been lost in response to receiving an MSI indicating an interrupt event for the given interrupt target when the interrupt information for the given interrupt target indicates that an interrupt is pending or receiving an MSI that indicates that an interrupt event for the given interrupt target was lost.

Example 14 includes the subject matter of example 9, including or omitting optional elements, wherein the interrupt source is further configured to translate respective wired interrupts into respective MSIs; detect that an interrupt signal for a second interrupt event for a given interrupt target is received prior to transmitting an MSI for a first interrupt event for the given interrupt target; and, in response store an indication that an interrupt was lost for the given interrupt target; and encode lost interrupt information in a first MSI for the first interrupt event.

Example 15 includes the subject matter of example 14, including or omitting optional elements, wherein the interrupt source is further configured to clear the indication that an interrupt was lost in response to transmitting the first MSI.

Example 16 includes the subject matter of example 9, including or omitting optional elements, wherein the MSI controller is configured to signal the indication of one or more lost interrupt events on a per interrupt priority basis.

Example 17 includes the subject matter of example 9, including or omitting optional elements, wherein the MSI controller is configured to signal the indication of one or more lost interrupt events on a per interrupt target basis.

Example 18 includes the subject matter of example 9, including or omitting optional elements, wherein the MSI controller is configured to reset the lost interrupt information for an interrupt target in response to an interrupt target having the same or greater privilege than the interrupt target receiving the indication of the one or more lost interrupt events.

Example 19 is a method, including: receiving interrupt messages that include an indication of an interrupt priority of a plurality of interrupt priorities; and based on the interrupt messages, determining that an interrupt for a given interrupt priority was lost; and providing, to a computing core, respective lost interrupt information for the respective interrupt priorities, the lost interrupt information indicating whether an interrupt was lost.

Example 20 includes the subject matter of example 19, including or omitting optional elements, further including setting an IL bit mapped to the interrupt priority in an interrupt file in response to receiving an MSI that includes an indication of the interrupt priority and an indication that a vector IL bit in an interrupt source vector for the interrupt priority is set.

Example 21 includes the subject matter of example 19, including or omitting optional elements, further including setting an IL bit mapped to the interrupt priority in an interrupt file in response to receiving an MSI that includes an indication of the interrupt priority while an IP bit for the interrupt priority in the interrupt file is set.

Example 22 includes the subject matter of example 21, including or omitting optional elements, further including resetting an IL bit mapped to a given interrupt priority in the interrupt file in response to resetting an IP bit mapped to the given interrupt priority in the interrupt file.

Example 23 is a method, including receiving external interrupt signals, each associated with an interrupt priority; based on the received interrupt signals, determining that an interrupt signal for a given interrupt priority has been lost; and providing an indication to a computing core that the interrupt signal for the given interrupt priority has been lost.

Example 24 includes the subject matter of example 23, including or omitting optional elements, further including providing a plurality of respective vectors connected to respective external interrupt inputs that receive the external interrupt signals, wherein each vector is associated with a target computing core, further wherein each vector includes an indication of an interrupt priority, a vector interrupt pending (IP) bit, and a vector interrupt lost (IL) bit; and setting the vector IL bit of a vector when an interrupt is received by a corresponding external interrupt input while the vector IP bit of the vector is set.

Example 25 includes the subject matter of example 24, including or omitting optional elements, further including selecting a vector based on arbitration rules; and transmitting a message signaled interrupt (MSI) to an incoming MSI controller (IMSIC) connected to a target computing core of the selected vector, the MSI including an indication of the interrupt priority of the selected vector and a status of the vector IL bit of the selected vector.

Various illustrative logics, logical blocks, modules, circuitries, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

In the present disclosure like reference numerals are used to refer to like elements throughout, and wherein the illustrated structures and devices are not necessarily drawn to scale. As utilized herein, terms “module”, “component,” “system,” “circuit,” “circuitry,” “element,” “slice,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein the term “or” includes the option of all elements related by the word or. For example A or B is to be construed as include only A, only B, and both A and B. Further the phrase “one or more of” followed by A, B, or C is to be construed as including A, B, C, AB, AC, BC, and ABC.

What is claimed is:

1. A reduced instruction set computer-V (RISC-V) architecture, comprising:
an advanced platform level interrupt controller (APLIC) comprising a plurality of respective vectors connected to respective external interrupt inputs, wherein each vector is mapped to an interrupt priority and each vector comprises a vector interrupt lost (IL) bit; and
an incoming message signaled interrupt (MSI) controller (IMSIC) coupled to the APLIC, the IMSIC configured to receive MSI from the APLIC and to maintain an interrupt file that includes a set of a set of interrupt lost (IL) bits indexed by interrupt priority.

2. The RISC-V architecture of claim 1, wherein the IMSIC is configured to set an IL bit mapped to a given interrupt priority of the interrupt file in response to
receiving a message signaled interrupt (MSI) that includes an indication of the given interrupt priority and an indication that a vector IL bit of a corresponding vector is set; or
receiving an MSI that includes an indication of the given interrupt priority while an interrupt pending (IP) bit for the given interrupt priority in the interrupt file is set.

3. The RISC-V architecture of claim 1, wherein the IMSIC is configured to reset an IL bit mapped to a given interrupt priority in the interrupt file in response to resetting an IP bit mapped to the given interrupt priority in the interrupt file.

4. The RISC-V architecture of claim 1, wherein the APLIC is configured to
set the vector IL bit of a vector when an interrupt is received by a corresponding external interrupt input while an IP bit of the vector is set; and
in response, transmit an MSI to the IMSIC, the MSI including an indication of the interrupt priority of the vector and a status of the vector IL bit of the vector.

5. The RISC-V architecture of claim 1, wherein
the respective vectors are each mapped to a respective interrupt target and a respective interrupt priority of the respective interrupt target; and
the IMSIC maintains an interrupt file for each interrupt target.

6. The RISC-V architecture of claim 5, wherein an interrupt target comprises
a target hardware thread (hart),
a target hart and a privilege level of the target hart, or
target hart and virtual machine ID of the target hart.

7. The RISC-V architecture of claim 1, wherein the APLIC is configured to set an IL bit mapped to a given interrupt vector in response to receiving a new interrupt for the given interrupt vector while an interrupt pending (IP) bit for the given interrupt vector is set.

8. The RISC-V architecture of claim 1, wherein the APLIC is configured to reset an IL bit mapped to a given interrupt vector in response to resetting an interrupt pending (IP) bit mapped to the given interrupt vector when a corresponding interrupt is signaled as an MSI.

9. An interrupt architecture, comprising
hardware components arranged into one or more hardware threads (harts);
an interrupt source configured to
receive respective external interrupt signals indicative of respective interrupt events, each interrupt event having a corresponding interrupt target, wherein each interrupt target corresponds to an interrupt priority at a target hart of the one or more harts;
based on the received interrupt signals, transmit message signaled interrupts (MSIs), wherein an MSI includes, for an interrupt event, information about the interrupt target of the interrupt event;
an MSI controller configured to
receive MSIs from the interrupt source;
based on the received MSIs, store interrupt information for interrupt targets;
determine that an interrupt event for an interrupt target has been lost; and
in response, provide lost interrupt information to a target hart of the interrupt target, the lost interrupt information comprising an indication of one or more lost interrupt events.

10. The interrupt architecture of claim 9, wherein the interrupt target comprises an interrupt priority at a privilege level at the target hart or a virtual machine at the target hart.

11. The interrupt architecture of claim 9, wherein an MSI of the MSIs that indicates an interrupt event for a given interrupt target includes an indication that an interrupt signal for a subsequent interrupt event for the given interrupt target was received prior to transmission of the MSI.

12. The interrupt architecture of claim 11, wherein the MSI controller is further configured to
based on the received MSIs, save interrupt information for each interrupt target, the interrupt information indicating whether an interrupt has been lost; and
provide lost interrupt information to a target hart associated with the interrupt target for which the interrupt was lost.

13. The interrupt architecture of claim 9, wherein the MSI controller is configured to set the interrupt information for a given interrupt target to indicate that an interrupt has been lost in response to receiving an MSI indicating an interrupt event for the given interrupt target when the interrupt information for the given interrupt target indicates that an interrupt is pending or receiving an MSI that indicates that an interrupt event for the given interrupt target was lost.

14. The interrupt architecture of claim 9, wherein the interrupt source is further configured to
translate respective wired interrupts into respective MSIs;
detect that an interrupt signal for a second interrupt event for a given interrupt target is received prior to transmitting an MSI for a first interrupt event for the given interrupt target;
and, in response
store an indication that an interrupt was lost for the given interrupt target; and
encode lost interrupt information in a first MSI for the first interrupt event.

15. The interrupt architecture of claim 14, wherein the interrupt source is further configured to clear the indication that an interrupt was lost in response to transmitting the first MSI.

16. The interrupt architecture of claim 9, wherein the MSI controller is configured to signal the indication of one or more lost interrupt events on a per interrupt priority basis.

17. The interrupt architecture of claim 9, wherein the MSI controller is configured to signal the indication of one or more lost interrupt events on a per interrupt target basis.

18. The interrupt architecture of claim 9, wherein the MSI controller is configured to reset the lost interrupt information for an interrupt target in response to an interrupt target having the same or greater privilege than the interrupt target receiving the indication of the one or more lost interrupt events.

19. A method, comprising:
receiving interrupt messages that include an indication of an interrupt priority of a plurality of interrupt priorities; and
based on the interrupt messages, determining that an interrupt for a given interrupt priority was lost; and
providing, to a computing core, respective lost interrupt information for the respective interrupt priorities, the lost interrupt information indicating whether an interrupt was lost.

20. The method of claim 19, further comprising setting an IL bit mapped to the interrupt priority in an interrupt file in response to receiving an MSI that includes an indication of the interrupt priority and an indication that a vector IL bit in an interrupt source vector for the interrupt priority is set.

21. The method of claim 19, further comprising setting an IL bit mapped to the interrupt priority in an interrupt file in response to receiving an MSI that includes an indication of the interrupt priority while an IP bit for the interrupt priority in the interrupt file is set.

22. The method of claim 21, further comprising resetting an IL bit mapped to a given interrupt priority in the interrupt file in response to resetting an IP bit mapped to the given interrupt priority in the interrupt file.

23. A method, comprising:
receiving external interrupt signals, each associated with an interrupt priority;
based on the received interrupt signals, determining that an interrupt signal for a given interrupt priority has been lost; and
providing an indication to a computing core that the interrupt signal for the given interrupt priority has been lost.

24. The method of claim 23, further comprising:
providing a plurality of respective vectors connected to respective external interrupt inputs that receive the external interrupt signals, wherein each vector is associated with a target computing core, further wherein each vector comprises an indication of an interrupt priority, a vector interrupt pending (IP) bit, and a vector interrupt lost (IL) bit; and
setting the vector IL bit of a vector when an interrupt is received by a corresponding external interrupt input while the vector IP bit of the vector is set.

25. The method of claim 24, further comprising:
selecting a vector based on arbitration rules; and
transmitting a message signaled interrupt (MSI) to an incoming MSI controller (IMSIC) connected to a target computing core of the selected vector, the MSI including an indication of the interrupt priority of the selected vector and a status of the vector IL bit of the selected.
